(19) United States
(12) Patent Application Publication
(10) Pub. No.: US 2006/0075872 A1
(43) Pub. Date: Apr. 13, 2006

(54) Easily adjustable mandolin type food slicer

(76) Inventor: Eric J. Wangler, Orchard Park, NY (US)

Correspondence Address: John C. McMahon, PO Box 30069, Kansas City, MO, 64112, US

(21) Appl. No.: 10/961,859

(22) Filed: Oct. 8, 2004

(51) Int. Cl. B26D 1/02

(52) U.S. Cl. 83/856; 83/932

(57) ABSTRACT

An easily adjustable food slicer for cutting various foods having a frame with a sloped cutting surface that is equipped with interchangeable cutting blades that face a selectively positioned primary ramp that is pivotally joined to the frame opposite the location of the blades. The ramp is removable and has a non-abrasive, smooth surface that can be raised or lowered by the use of an infinitely-adjustable cam. The cam has a knob located on a side surface of the frame and can be adjusted at anytime before and during a process allowing a user to vary the thickness of the slice of food. Also provided is an alternative secondary ramp with an abrasive, grating surface for grating food that can be installed after removal of the primary ramp.

### BACKGROUND OF THE INVENTION

The present invention is directed to a manual food slicing device for domestic and commercial users and especially to such a cutting device having a cutting surface adapted to be easily adjusted in order to manipulate thickness of each slice.

Devices designed to aid in the slicing of food, particularly meat, fruit and vegetables have long been employed in kitchens throughout the world. The purpose of such slicing devices is to process a bulky unit of food such as a potato by reducing the size and/or shape of the food to facilitate introduction into various recipes and applications or simply to make subsequent pieces easier to eat by means of utensils or hand. Traditional slicers of this nature have a cutting or slicing surface that is elevated with respect to at least one cutting blade and may be selectively used with or without a pusher or food holder.

If the device is equipped with a pusher, a typical method of use consists of positioning a unit of food within the pusher and then traversing the pusher up and down a ramp, which causes the pusher contents to be driven into the cutting blade so that a lower slice is cut from the bulk. If the device is not equipped with a pusher, a typical method of use consists of positioning a unit of food onto a ramp and pushing it down the ramp directly with the hand and against the cutting blade. With either method, the sliced portion of food drops through a slot to an area below the slicing surface onto a plate or the like.

In many applications, it is desirable for the slicer to shave off an extremely thin slice from the initial unit, which requires the device's cutting blades to be especially sharp. As such, it is necessary that adequate safeguards are employed to ensure the safety of the operator, thus avoiding inadvertent injury resulting from misuse of the device.

It is important to design the device with the knowledge that such devices are likely to be used domestically and in the home by non-professionals, which includes but is not limited to children who may not be familiar with the device, aware of the dangers presented from misuse and/or even recognize what is proper use and misuse. Safety measures often include the optional holder or pusher, which can be provided to remove and otherwise distance the user's hand away from the object being sliced and the cutting blade. Furthermore, it is preferred to have a device that is easily cleaned and does not collect debris so as to reduce the maintenance required during operation and essentially reduce hand contact required with the blades and thus lowers the likelihood of injury.

Such devices with blades and structure that can be adjusted to vary slice thickness are desirable in that a user is then able to vary the slice or cut of an object in the middle of an operation or for different foods. It is again desirable to require minimal hand contact with the blades by providing a swift and efficient means for removing, replacing or altering the blade. The current designs for such cutting devices are somewhat awkward requiring various latching or swiveling of the blades. Thus, there is a need to provide a thin-cutting device that offers operators means for easily adjusting blades, that does not retain debris and controls and secures the holder to avoid inadvertent slipping off the food engaging face of the device.

### SUMMARY OF THE INVENTION

The present invention is directed to a food slicer having improved ease of operation and, especially, provides an easily-adjustable mandolin type food slicer having a sloped ramp with either an abrasive and grating surface for providing a grating cut, or a non-abrasive smooth surface for use with different selectively removable blades that provide for a slicing and/or slicing and dicing cut (julienne cut) and/or grater type abrasion. The ramp can be easily adjusted via an infinitely-adjustable cam for raising and lowering the ramp before and/or during use.

### OBJECTS AND ADVANTAGES OF THE INVENTION

Therefore, the objects of the present invention are: to provide an easily adjusted food slicer with a plurality of interchangeable blades for variable cutting or slicing ability, which are easily removable; to provide such a device designed to promote easy cleaning and maintenance; to provide such a slicer with a plurality interchangeable receiving ramps both abrasive and non-abrasive; to provide such a slicer wherein the ramp to blade distance, which dictates the width of food sliced, is controlled by an infinitely adjustable cam to provide such a slicer wherein the cam is rotated and adjusted by an easily accessible operator knob; to provide such a device wherein the cam is independent of the blade such that infinitely variable slicing or julienne cuts may be made; to provide such a device having indicia associated with the cam knob that allows a user to gauge food thickness produced by placing the cam in a particular position; and to provide such a slicer that is easy to use, relatively easy to clean and inexpensive to produce, and that is especially well adapted for the intended usage thereof.

Other objects and advantages of this invention will become apparent from the following description taken in conjunction with the accompanying drawings wherein are set forth, by way of illustration and example, certain embodiments of this invention.

The drawings constitute a part of this specification and include exemplary embodiments of the present invention and illustrate various objects and features thereof.

### BRIEF DESCRIPTION OF THE DRAWINGS

FIG. 1 is a perspective view of an easily adjusted mandolin type manual food slicer depicting a smooth food ramp and an alternative abrasive grating ramp.

FIG. 2 is a side elevational view of the slicer showing knob for an infinitely-adjustable cam that positions the ramp.

FIG. 3 is a top plan view of the slicer.

FIG. 4 is a cross-sectional view of the slicer, taken along line 4-4 of FIG. 3, depicting the ramp and cam in a lowered position.

FIG. 5 is similar to FIG. 4 and is an enlarged cross-sectional view, taken along line 4-4 of FIG. 3, depicting the ramp and cam in a lowered position.

FIG. 6 is similar to FIG. 4 and is an enlarged cross-sectional view, taken along line 4-4 of FIG. 3, depicting the ramp and cam in a raised position.

FIG. 7 is a side elevational view of the slicer with a food receptacle and pusher mounted on the slicer.

FIG. 8 is a perspective and exploded view of the pusher.

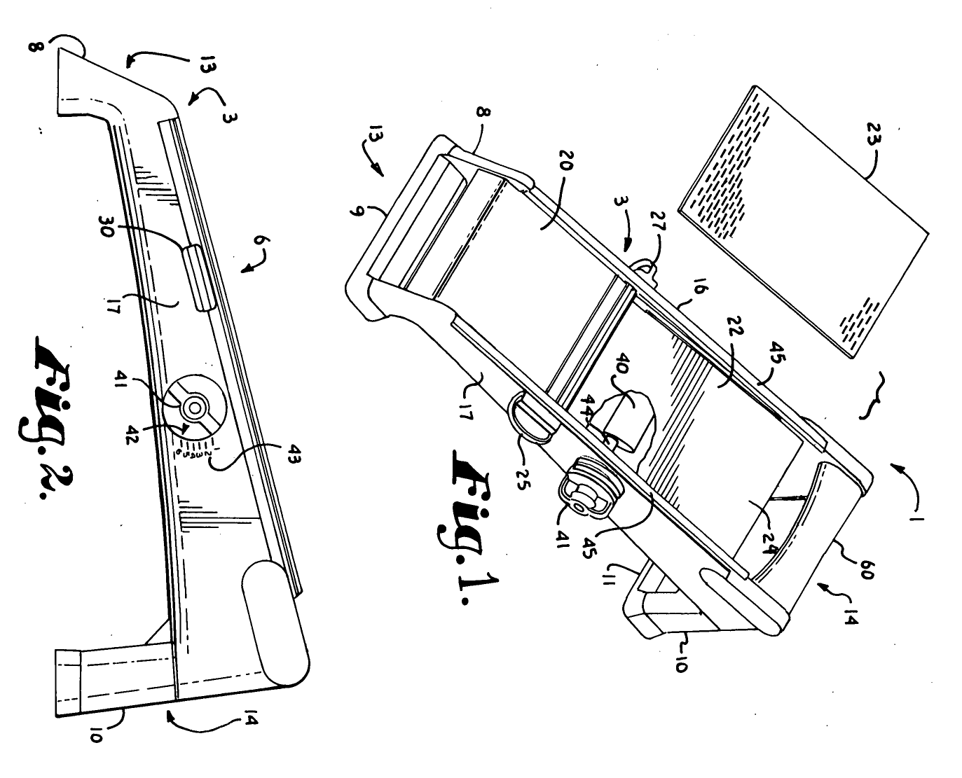

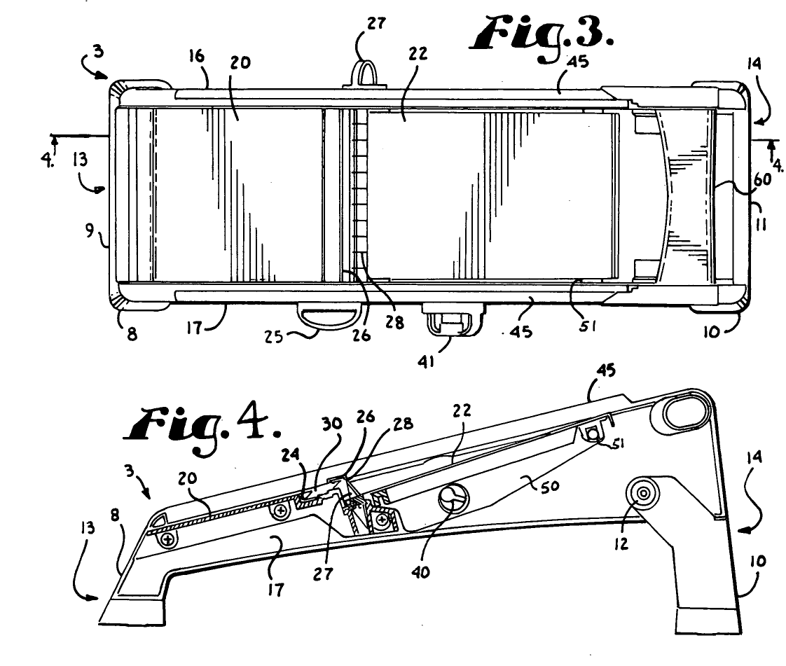

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

The reference number 1 generally represents an easily adjusted food slicer in accordance with the present invention. The slicer 1 primarily consists of a frame 3 having an elevated upward opening face 6 with front and rear legs 9 and 10 situated at front and rear ends 13 and 14 that are connected by parallel side panels 16 and 17. The rear leg 10 is longer than the front leg 9 so that when the slicer 1 is placed on a horizontal surface, such as a kitchen counter, the rear end 14 is elevated to a position higher than the front end 13, which causes the face 6 to be sloped at an angle such as 25 degrees. This is an advantageous configuration with respect to facilitating use of the slicer 1 and will be discussed further below.

The rear leg 10 is foldable and hinged to the remainder by a hinge 11 located at the rear end 14, as depicted in FIG. 4. The hinge 11 allows the rear leg 10 to be folded inward toward the remainder of the slicer 1 and parallel to the side surfaces 16 and 17 in order to provide a low-profile storage configuration when the slicer 1 is not in use.

The face 6 consists of a support and connecting plate 20 that is located toward the lower front end 13 and a ramp 22. The ramp 22 can be alternated or interchanged with a second ramp 23. The ramp 22 is removably mounted so as to extend from near the plate 20 to near the rear end 14, as well as being situated between the side panels 16 and 17. The ramp 22 is a primary ramp having a smooth, non-abrasive surface 24 and is used in combination with selected first and/or second removable blade cartridges 25 and 27. It is foreseen that in some embodiments the ramp 22 is integral with the side surfaces 16 and 17 and non removable. In such an embodiment, the ramp 22 would be flexible and fixedly joined near the rear thereof either to the rear 14 of the frame and/or the side panels 16 and 17.

The ramp 23 is a secondary ramp having a grating, abrasive surface and can be used in the device 1 without blade cartridges 25 and 27 to grate food such as cheese. Further, it is foreseen that the blade cartridges 25 and 27, can be replaced with a grater cartridge so that food can be grated by the device 1.

The support plate 20 has an upper end 24 on which the selectively removable first blade cartridge 25 slides onto and rests against by insertion through an opening 30 therefor in the side panel 17. The first blade cartridge 25 is installed along the upper end 24 by sliding the blade through the opening 30. The plate upper end 24 has a track 32 that extends between side panels 16 and 17 and aids in guiding the first blade cartridge 25 into position during installment. The first blade cartridge 25 has a blade or cutting edge 26 that is generally parallel to the face 6, which results in an angled upward slope toward the primary ramp 22 and rear end 14.

Situated between the first blade cartridge 25 and the ramp 22 is the selectively removable second blade cartridge 27 with a blade or cutting edge 28. The edge 28 includes a plurality of individual and equally spaced upright segments that run from front to rear and that are generally perpendicular to the face 6. Either of the first blade cartridge 25 or second blade cartridge 27 may be used alone or in combination with the other depending on the desired cut. Specifically, the vertical cutting edges 28 of the second blade cartridge 27 are configured to be used in order to provide a vertical cutting option, which is commonly referred to within the art as dicing or preforming a julienne type cut when used with the horizontal blade of blade cartridge 25. In accordance with the invention, the vertical position of the ramp 22 can be varied in position relative to the blade cartridges 25 and 27 to allow infinite adjustment of the slice thickness of the food, if just cartridge 25 is used, or infinite adjustment of the cross section of a julienned strip, if both blade cartridges 25 and 27 are used.

The ramp surface 22 has a front edge 35 that is positioned facing downward toward the cutting edge 26 of the first blade cartridge 25. Between the front edge 35 and the first blade cartridge 25 is a variable height slot 37 that is provided to allow the sliced food to pass through the face 6 and onto either the counter, a plate or other like device where the processed food can be collected easily. The height of the slot 37 is effectively determined by an infinitely adjustable cam 40 that abuts the ramp 22 either by directly engaging the underside of the ramp 22 or structure secured or fixedly attached to the ramp 22, as described below. Notably, the types of foods processed by the slicer 1 include both sliced food, julienned food and grated food from the grater ramp 23, as the ramps 22 and 23 are interchangeable by lifting one out and replacing it with the other.

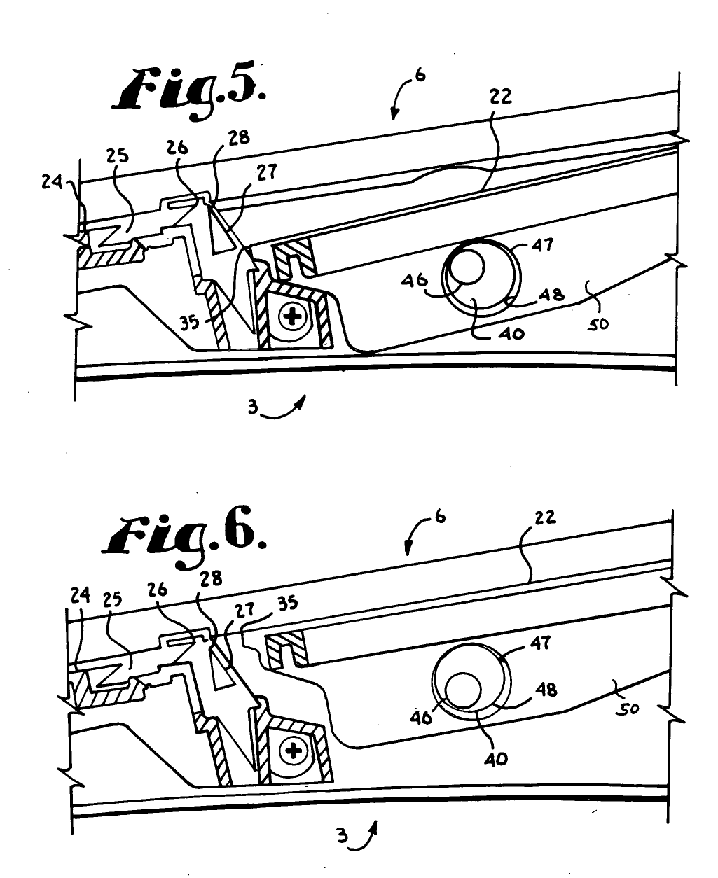

In particular, the ramp 22 is raised and lowered relative to the blade cartridge 25 by the use of the cam 40. The cam 40 has an outwardly extending knob 41 that extends from the side surface 17 and allows the user to rotate the cam 40 in order to manipulate and achieve a desired cut thickness. The cam 40 is infinitely adjustable simply by rotating through a substantial arc; however, on the side panel 17 is an indicator 42 with an indicia 43 consisting of a group of letters, numbers or the like in order to allow the user to choose from a variety of preselected cam 40 positions out of an infinite variety for raising and lowering the ramp 22 in order to obtain a desired cut or to use in allowing the user to estimate the thickness of a food slice. The cam 40 generally extends between the side panels 16 and 17 and includes a central shaft 44 having ends that are pivotally received relative to the side panels 16 and 17. In the illustrated embodiment, the cam 40 includes a generally cylindrical surface 48 that is offset axially from the shaft 44. As the cam 40 rotates, the ramp 22 is raised or lowered to vary the food cutting width by changing the distance between the front end 35 of the ramp 22 and the blade 26. The ramp 22 is seen near its lowest position (where food slice width is greatest in FIGS. 4 and 5) and near its highest position (where food slice width is least in FIG. 6). While a cylindrical cam surface is used in the present embodiment, it is foreseen that other surfaces could be utilized for the cam action.

Seen in FIGS. 5 and 6, the cam surface 48 operably abuts against a circular opening 47 in a pair of ramp guides 50 pivotally connected to the side panels 16 and 17 by pivots 51. The guides 50 run from near the plate 20 to near the rear panel 14 parallel to the side panels 16 and 17 to which the guides 50 are pivotally attached near the rear end thereof. The openings 47 are slightly larger than the cam surface 48 and follow the cam surface 48 as it rotates to operably raise or lower the front ends thereof. The ramp 22 operably sets on and follows the guides 50.

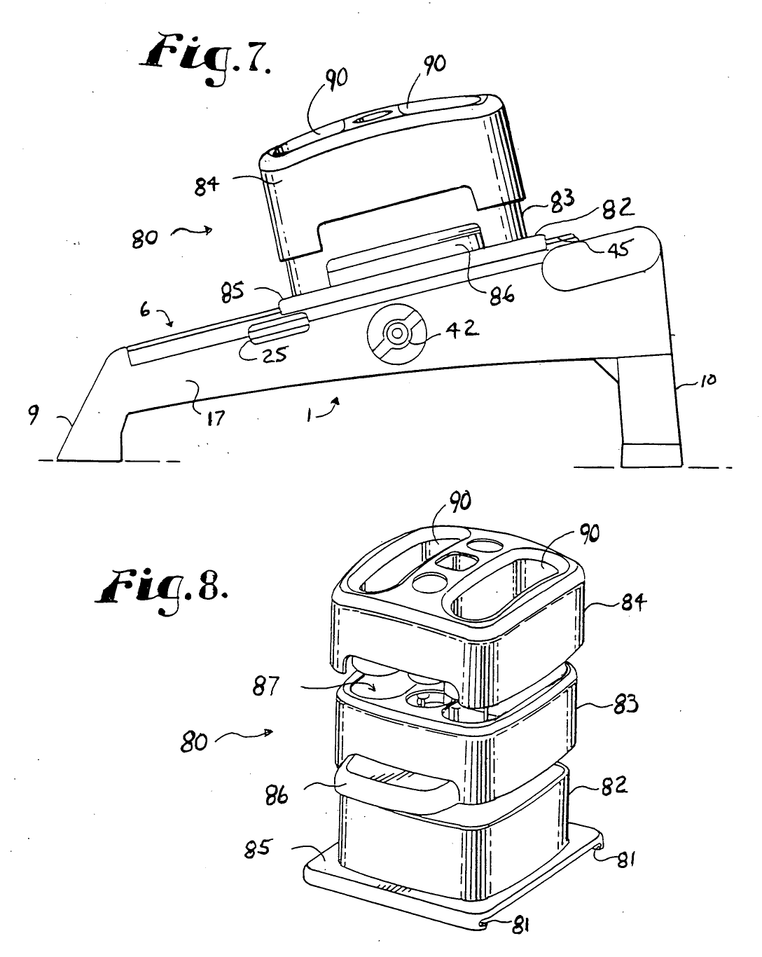

On either side of the face 6 and at the side surfaces 16 and 17, are ramp guides or tracks 45. In the present embodiment, the tracks 45 are situated slightly above the face 6 and run the length of the face 6. The tracks 45 are designed to engage a food-pusher assembly 80, seen in FIGS. 7 and 8, for the purpose of guiding the pusher assembly along the length of the face surface 6. In the preferred use, the pusher 80 is equipped with corresponding track receivers 81 and is mounted onto the face 6 by aligning the receivers 81 with and engaging the end of the tracks 45, which are located at the rear end 14 of the slicer 1. The engagement of tracks 45 provide guidance for the pusher 80 and ensures that the pusher 80 remains on the face 6.

The pusher 80 may be any suitable device of which various structures exist in the prior art. The illustrated pusher 80 is especially effective and has three telescoping and nesting sections 82, 83 and 84. The lower section 82 includes a base 85 with the track receivers 81. The middle section 83 mounts over the section 82 and has outwardly extending handles 86 and an upper face with openings 87 therein. The upper section 84 mounts over the middle section 83 and has receptacles 90 extending downwardly from the interior thereof to operably receive the fingers of a user. The sections 82, 83 and 84 telescope upward to receive food and pressure by the hand of a user on the top section 84 drives the bottom surface or footprint of the receptacle 90 into the food to hold the food in place as the pusher 80 moves back and forth on the track 45 so as to cut a slice of the food or dice a portion of the food with each pass.

At the rear end 14 of the frame 3 is a support handle 60 that helps a user to maintain the slicer 1 in a fixed position during use and especially if a pusher 80 is being traversed along the length of the face 6. As such, the slicer 1 is designed to be used with two hands with one hand of the user on the food being sliced or preferably on the pusher 80 in order to move the pusher 80 up and down the face 3 while the user's other hand balances and supports the slicer 1 with the handle 60.

In use, the user positions the food on the ramp 22 or 23 or may load the food into the pusher 80. If the smooth ramp 22 is selected for slicing, the user positions the ramp 22 at a desired level to obtain a desired cut thickness, by adjusting the cam 40. The thickness cut is indicated by the use of an indicator 42 and a corresponding indicia 43 that contains numbers or the like that indicate the thickness level, which is located on the side surface 17. The downward slope of the ramp 22 facilitates slicing as the food is positioned initially toward the upper end of the ramp 22 and is slid downward toward and against the blade 26. Depending on desired cut, the user can install and use the blade 26 in combination with the vertical blades 28 of the blade cartridge 27 to produce a dicing effect.

The sliced portion of the subject food falls through the slot 37 or the grated food passes through the grated ramp 23 with either processed food falling to a food catcher (not shown), such as a plate or the like, that is located below the face surface 6 while the remainder initial unit of the food remains in contact with the food-engaging surface 53. As the food is sliced or grated, the initial food unit becomes smaller and in order to maintain the desired cut, the user continues to exert downward pressure onto the food unit. The food is sliced or grated until either the user obtains a desired amount of processed food or the remainder portion of the food is depleted. Notably, the infinitely-adjustable cam 40 can be adjusted at anytime before, after and during use of the slicer 1. Use of the pusher 80 during cutting operations is preferred, especially as placement of the fingers in either of the receptacles 90 (depending on the selected orientation of the pusher 80) protects the fingers from engagement with the blades 26 and 28.

It is to be understood that while certain forms of the present invention have been illustrated and described herein, it is not to be limited to the specific forms or arrangement of parts described and shown.

What is claimed and desired to be secured by Letters Patent is as follows:

1. An adjustable food slicer, comprising a frame with:
a) two parallel side panels;
b) a ramp situated between said side panels;
c) a cutting blade situated at one end of said ramp; and
d) a cam located beneath and effectively engaging said ramp and operably adjustable to vary the height of said surface relative to said blade.

2. The slicer as in claim 1 wherein:
a) said ramp includes a sloped planar surface.

3. The slicer as in claim 1 wherein:
a) said ramp can be infinitely selectively raised or lowered relative to said blade through operation of said cam.

4. The slicer as in claim 1 wherein:
a) said ramp is part of a ramp structure including a pair of side guides pivotally connected to said frame opposite said blade.

5. The slicer as in claim 1 wherein:
a) said blade is mounted in a first cartridge; and
b) said frame includes a first aperture sized and shaped to receive said first blade cartridge.

6. The slicer as in claim 1 wherein:
a) said frame includes a second aperture sized and shaped to receive a second blade cartridge.

7. The slicer as in claim 1 wherein:
a) said frame has a base portion including a support track; and
b) a receptacle sideably mountable on said track adapted to receive food and move such food back and forth on said ramp while following said track.

8. The slicer as in claim 1 wherein:
a) said ramp is removable.

9. The slicer as in claim 8 including:
a) a grater structure that is alternatively positionable on said frame to grate food.

10. The slicer according to claim 1 wherein:
a) said cam includes a shaft axially and rotatably mounted between said sides; and
b) a cylindrical cam surface mounted asymmetrically on said shaft and positioned such that said cam surface communicates with said ramp to operably modify the position of the ramp as said cam rotates.

11. The slicer according to claim 10 wherein:
a) said ramp includes a planar surface and a pair of guides depending below the planar surface; and
b) each of said guides has an opening through which said cam passes with an interior of said openings engaging said cam such that said cam transmits an elevational position to said ramp through said guides.

12. In a food slicer having a food receiving ramp structure mounted on a frame and with a blade located near one end of the ramp; the improvement comprising:
a) an adjustable cam that operably engages said ramp structure so as to adjust the height of a food receiving surface of the ramp relative to the blade in accordance with operator rotation of the cam.

13. The slicer according to claim 12 wherein:
a) the cam adjusts the height of the ramp independently of the blade.

14. The slicer according to claim 12 wherein:
a) the cam is infinitely adjustable.

15. The slicer according to claim 12 wherein:
a) the ramp rests on and is pivotally joined opposite the blade to the frame through a pair of opposed guides.

16. The slicer according to claim 12 including:
a) said blade is at least one horizontal blade that is independently supported by the frame relative to the ramp and the cam.
